(19) United States
(12) Patent Application Publication
(10) Pub. No.: US 2024/0150254 A1
(43) Pub. Date: May 9, 2024

(54) Mineral Supplement Including Microbes to Promote Growth in Agriculture

(71) Applicant: Parshuram Nirajan Shastri, Manhattan Beach, CA (US)

(72) Inventor: Parshuram Nirajan Shastri, Manhattan Beach, CA (US)

(21) Appl. No.: 18/504,810

(22) Filed: Nov. 8, 2023

Related U.S. Application Data
(63) Continuation of application No. 16/938,867, filed on Jul. 24, 2020, now abandoned.
(60) Provisional application No. 62/878,041, filed on Jul. 24, 2019.

(51) Int. Cl. C05F 17/80; C02F 1/26; C05G 5/10; C05G 5/23

(52) U.S. Cl. CPC C05F 17/80; C02F 1/265; C05G 5/10; C05G 5/23; C02F 2103/08

(57) ABSTRACT

A system and method for preparing a microbial supplement, and applying the supplement to plants, trees and other items to promote their growth. The supplement comprises seawater, including microbes that naturally exist in seawater. Seawater is harvested containing microbes in an inactive or dormant state. The seawater undergoes a filtration, mineralization and oxygenation process to reduce sodium chloride levels, to increase the levels of desirable minerals in the seawater and to oxygenate the seawater to keep the microbes alive, though in a dormant or inactive state. The microbes are maintained in an inactive or dormant state through the preparation process, but become active when the supplement is applied to plants or trees, thereby promoting agricultural growth.

### CROSS-REFERENCE TO RELATED APPLICATION

This application is a continuation of application Ser. No. 16/938,867, filed Jul. 24, 2020, which claims the benefit of U.S. Provisional Application No. 62/878,041, filed Jul. 24, 2019, the contents of which are incorporated herein by reference.

### FIELD OF THE INVENTION

The current invention generally relates to materials for promoting growth in agriculture, such as promoting the growth of plants and trees. The current invention includes the preparation and application of supplements derived from seawater that includes microbes and minerals.

### BACKGROUND OF THE INVENTION

Various types of fertilizers, supplements and other substances have been used to promote growth in agriculture, including plants and trees. This has included the use of seawater-based products because of the nutrients and minerals that seawater contains. Because naturally-existing seawater contains too much salt to use as a fertilizer or supplement in its natural form, existing seawater-based products typically undergo some type of filtration process to lower the levels of sodium and chloride, while retaining levels of minerals naturally existing in the seawater that are considered to promote growth in plants and trees.

Most of these products typically rely on the minerals existing in seawater as the component that promotes agriculture growth. These products have not recognized that microbes existing in seawater may promote agricultural growth. If microbes do exist in such products, the microbes have typically died off before the product is applied to plants and trees, and thus play no role in promoting growth. As such, there is a need for a supplement that involves microbes existing in seawater, where the microbes are living when applied to plants and trees thereby promoting their growth.

Efforts have been made to develop a supplement that contains living microbes, such as the Rhizolizer® soil amendment provided by Locus Agricultural Solutions of Solon, Ohio. However, this product has significant restrictions because its manufacture, distribution and application to the soil, plants and trees must all occur within a limited timeframe, because otherwise, the microbes would apparently die off before engaging the plants or trees or surrounding soil.

To this end, the Rhizolizer® product must apparently be prepared near the farm or other location where it will ultimately be applied. Furthermore, it must apparently then be delivered quickly to the agriculture using Locus' proprietary cold chain process. Still further, the Rhizolizer® product must apparently be used within six hours of being mixed with water.

All these requirements for expedited handling can create significant logistical issues for farmers. And if the expedited schedule is not met, time and product will have been lost. It also appears that the benefits of the Rhizolizer® product essentially rely only or primarily on microbes; it thus appears that the minerals existing in seawater are not significantly used. Accordingly, there is a need for a supplement involving microbes that is not burdened by the handling issues described above, and that uses the benefits of both microbes and seawater minerals.

Existing seawater-based products have also used acidic substances to decrease levels of sodium and chloride and to otherwise balance their chemical composition. However, these products must typically be used within a certain timeframe or else the acidic substances detract from, or eliminate, the nutritional benefits of the minerals existing in the product. As such, there is a need for a supplement that does not involve the use of acidic substances so that the time restrictions such acidic substances create may be avoided.

Fields in farms and other agricultural settings are often fertilized with nitrogen-based fertilizers or supplements. This may result in a significant presence, or even contamination of nitrogen in these fields. An issue arises if the field is then rained on. In this situation, much of the nitrogen-based fertilizer may be washed away and end up in rivers, lakes or the ocean. The result may be a petri dish of contaminants being flushed into bodies of water, thereby spawning algae blooms or other forms of contamination. As such, there is a need for a fertilizer or supplement that avoids “nitrogen blasting” of fields and contamination due to rains.

Skepticism has been expressed in articles over the benefits of using seawater as a fertilizer or as a supplement to promote growth in plants or trees. However, those articles typically address products focusing on the minerals existing in seawater; they do not address any products involving the benefits of microbes in connection with seawater minerals.

In view of the foregoing, there is a need for a supplement that involves the benefits of microbes along with seawater minerals to promote the growth of agriculture.

### SUMMARY OF THE INVENTION

An aspect of the invention involves seawater-based supplements that have novel formulations and compositions and that involve microbes and minerals to promote agricultural growth.

Another aspect of the invention is the use of microbes that are initially in a dormant or inactive state during harvesting, preparation and storage, but become active before or as the supplement is applied to agriculture, such as plants or trees or their surrounding soil, so as to help promote their growth. That the microbes are in a dormant state prior to the supplement being applied provides significant logistical and efficiency benefits, because expedited handling is not required to avoid the microbes dying off.

Another aspect of the invention involves a treatment process, including filtration to reduce sodium and chloride levels in the seawater and to purify the seawater and/or to help keep the microbes alive, but in a dormant state, during filtration.

Another aspect of the invention is the application of the supplement to agriculture, such as plants or trees. The supplement is preferably sprayed on plants or trees so that the supplement may penetrate the leaves and other parts of the plant, so that the living microbes contained in the supplement may interact with the plant or tree and promote their growth. Alternatively, the supplement may be applied to the soil surrounding the plants or trees.

Other aspects of the invention are discussed herein.

### BRIEF DESCRIPTION OF THE DRAWINGS

FIG. 1 is a flowchart showing the steps for preparing and applying a mineral supplement.

FIG. 2 shows a system for treating seawater.

FIG. 3 shows a system for treating seawater.

FIG. 3A shows a ramp providing a tortuous path.

FIG. 4 shows a system for treating seawater.

### DETAILED DESCRIPTION OF THE PREFERRED EMBODIMENTS

Ocean water, or seawater, contains various types of minerals, sea life and other items depending on the depth of the seawater. At sufficient depths below the ocean surface, seawater may contain naturally existing minerals and living, active microbes. For example, sulphur mountains may exist at certain depths which release microbes into the surrounding water. Plant life, which may also exist at certain depths, may also promote the generation or life of microbes.

At shallower depths, however, the changes in oxygen level and/or relative sunlight in the seawater create an environment such that the microbes do not remain in an active, living state. At these shallower depths, the microbes remain alive, but may go into a comatose, or dormant or inactive state because of the change in their environment. At even shallower depths, the microbes generally die off because the associated environment of oxygen and/or sunlight does not allow the microbes to remain living, even in a dormant state.

The current invention includes the use of these dormant or inactive microbes, as well as minerals existing in seawater at certain depths, in a supplement to promote the growth of agriculture, including plants, trees or other living items on land and the enrichment of soil.

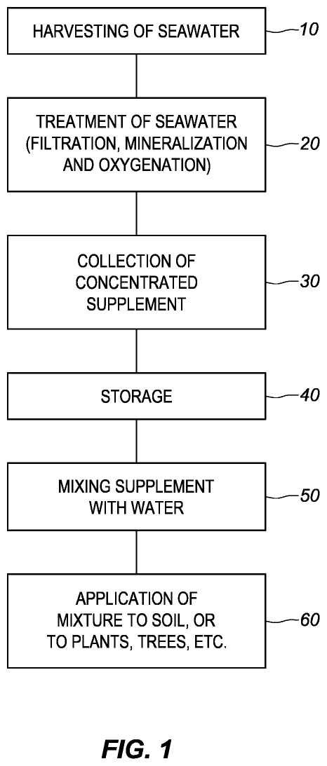

An overall process regarding aspects of the invention is shown in FIG. 1.

Seawater may first be harvested or obtained as in step 10. As discussed later in more detail, it is preferred that seawater is harvested at depths where microbes exist in a dormant state.

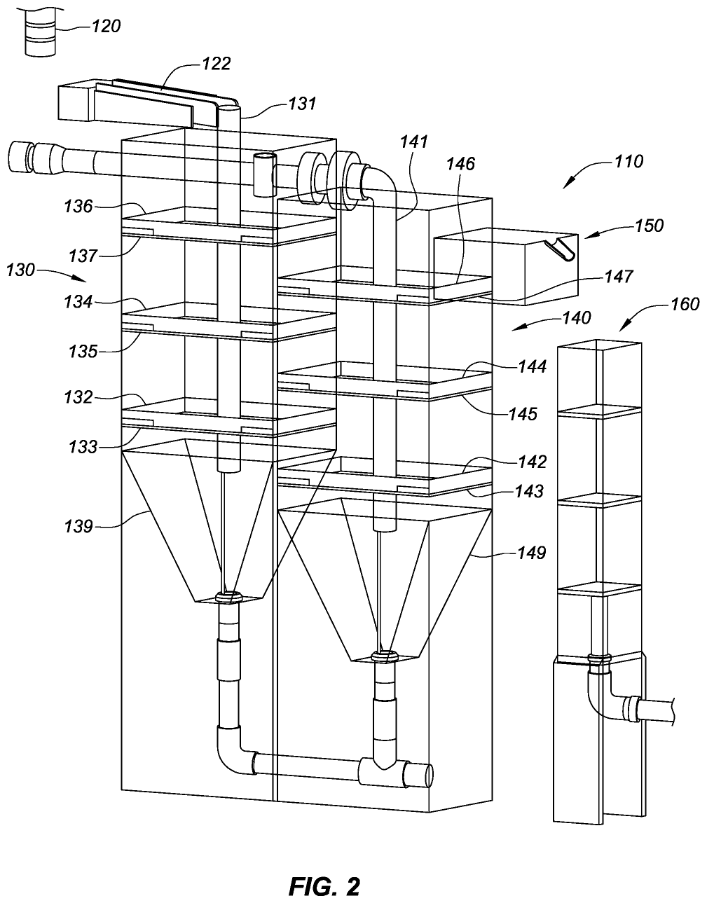

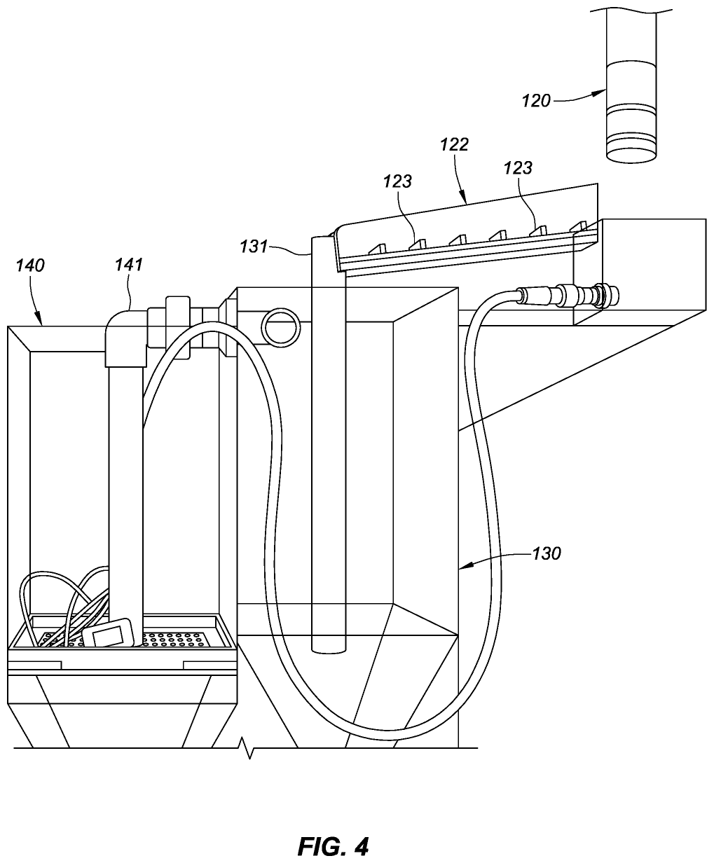

The harvested seawater may then undergo a treatment step 20, where the seawater is filtered and mineralized, as well as oxygenated. The system 110 as shown in FIGS. 2-4 may be used for the treatment step 20. However, other types of filtration systems may be used. During this step 20, sodium and chloride levels in the seawater are preferably reduced through a series of filters. Also during this step, desirable minerals that may contribute to agricultural growth may be imparted to the seawater. Also during this step, oxygen may be added to the seawater to help the microbes in the seawater preferably remain alive, though still in an inactive or dormant state.

The treated seawater may then be collected as in step 30. As discussed later in more detail later, this treated seawater or concentrate or supplement, which Applicant calls the OGROWING™ supplement or the supplement, includes a desired mix of minerals, and importantly, microbes that are still alive, though in an inactive or dormant state. The supplement may be in a liquid or powder form.

The treated seawater concentrate may then be stored as necessary as in step 40. It is preferred that the supplement be stored at a desired temperature range and other storage parameters, so that the microbes continue to remain living, through dormant, during storage step 40.

The treated seawater or concentrate or supplement, may then be mixed with water and/or other suitable materials, as in step 50, to prepare a mixture suitable for applying to soil or agriculture, including plants, trees or other living items for promoting growth. As discussed later, preferred percentages of water and the supplement are mixed which may provide oxygen (from a sufficient volume of water) to the microbes to help them later become active during the application step 60. The percentages of water and the supplement mixes may also vary according to the application in which the mixture will be used. For example, mixtures having more supplement may be preferred for applying to certain plants or soils.

The mixture of the supplement and water may then be sprayed or otherwise applied to soil, or to plants, trees or other items, as in step 60. The microbes in the supplement preferably become active during this step.

Activation of the microbes during the application step 60 is preferred because, for example, microbes may have a limited life span in water. And if the microbes had become active during the mixing step 50, or other earlier step, they may have died prior to being applied to soil, or to the plants, trees or other agriculture. Indeed, the limited lifespan of microbes apparently requires the expedited and controlled manufacture, distribution and application of Rhizolizer® as discussed above.

The oxygen in the environment surrounding the spraying or other application of the mixture may help render the dormant microbes active. The relative amount of sunlight or artificial light to which the microbes are exposed during the application step 60 may also help render the dormant microbes active.

It should be noted that some of the microbes may become active before the application step 60, and it may be that some percentage of such microbes die off before being applied to the agriculture. However, it is preferred that the majority of microbes become active during the application step 60 so that a significant percentage of microbes are alive when being applied to soil, or to the plants, trees and/or other agriculture.

The application process 60 preferably integrates the supplement into the soil, or to the plant or tree so that the now-active microbes may interact with the soil or its host plant or tree to help promote growth. For example, the now-active microbes may reside on the surface, or become embedded in the surface, of the host plant or tree and provide nutrients thereto. Furthermore, the now-active microbes may act as carriers of minerals that were harvested along with the seawater, thereby enriching the soil, and/or increasing the uptake of these minerals into the roots of the plants or trees, or into their leaves.

Each of the foregoing steps, as well as the systems involved therewith, are now further described with reference to FIGS. 2-4.

It is preferred that the seawater harvesting step 10 occur at a preferred range of seawater depths that contains a mix of desired minerals, as well as microbes that are in a dormant or inactive state. This is preferred because seawater at shallow depths does not contain microbes that are living in either an active or inactive state. Furthermore, while seawater at very deep depths may contain living, active microbes, if this very deep seawater were harvested, the active microbes may die when reaching the surface or when being harvested because of the significant change in environment, i.e., from an environment where the microbes are alive and active, to a drastically different environment where the microbes may simply die off. If the microbes were to die off during seawater harvesting, this would prevent the microbes from later becoming active and promoting growth before and/or when the supplement of the current invention is applied to soil, or to plants, trees or other live items.

In the harvesting step 10, it is preferred that the seawater harvested contains microbes that are alive, but in a dormant state. This is because if seawater containing live, active microbes were harvested, the microbes would generally die off during the harvesting step 10 or later steps associated with the current invention, i.e., before the microbes are applied to the desired agricultural items. The benefits of maintaining the microbes in a dormant state are significant. This is shown by the expedited preparation, distribution and application that must occur with supplements such as Rhizolizer® soil amendment. It is also preferred that the environment surrounding the seawater as it is harvested, and thus surrounding the microbes, is maintained so that the microbes remain alive, though in a dormant state.

As discussed later, it is preferred that the microbes remain alive so that they may later become active when the mixture containing the supplement is applied to soil, or to plants, trees or other agricultural items to promote their growth. The use of microbes represents a significant advance in agriculture, because upon contacting or otherwise being integrated into soil, or to a plant, tree or other living item, the microbes may act as carriers for the nutrients harvested with the seawater so that the minerals enrich the soil. Indeed, without the activated microbes acting as carriers, the nutrients would not be effectively integrated into the soil, or into plants or trees. The microbes may also promote growth as they ultimately die off and decompose in the soil, plants or trees.

In sharp contrast, existing fertilizers and mineral concentrates involving seawater do not at all involve the benefits of microbes. Instead, in these existing materials, the microbes generally die off during the harvesting or later processing steps, so that the microbes have all died off by the time these existing materials are applied to agriculture. As such, the microbes play no part in later promoting the growth of plants or trees. Alternatively, products that do involve active microbes throughout the preparation, distribution and application steps are burdened with a “race-against the clock” to apply the supplement before the microbes die off.

The depth at which seawater, and thus dormant microbes, are harvested may generally depend on the location and clarity of the seawater. For example, in locations where the seawater is turbid and/or where sunlight does not penetrate to significant depths, seawater may be harvested at relatively shallow depths. The microbes will be dormant at those shallow depths because there is insufficient sunlight to keep those microbes in a live, active state.

However, where the seawater has greater clarity and/or where sunlight penetrates to deeper depths, e.g., in placid, tropical ocean environments, seawater and its dormant microbes are preferably harvested at deeper depths. This is because at shallower depths, there may be ample sunlight so that the microbes are in a live, active state. But at the preferred deeper harvesting depths in clear, placid seawater, there is once again insufficient sunlight to keep microbes in a live, active state; so that the microbes are in the desired dormant state.

It is also preferred that seawater be harvested at locations and depths where desirable minerals exist. Seawater generally contains a number of base minerals, as well as significantly more, e.g., thousands of, trace elements. The trace minerals play a significant role in enriching soil and promoting growth when the supplement, such as soil amendment, is applied.

That is, these trace minerals may be carried by the now-active microbes to integrate with the soil or directly to the plant or tree. For example, the organic soil amendment derived from the ocean is preferably dense microbe, trace mineral compound that when applied improves soil health and helps plants uptake nutrients and water more efficiently. Scientific studies have proven an increase in nutrient uptake, increased root mass, improved photosynthesis, increased stomatic conductance, and overall size and health of the plant and soil.

The desirable trace minerals generally do not exist at the ocean surface, but are more prevalent near the ocean floor. In certain locations, such as Southern California, seawater may be harvested at a depth of about 20-50 m, where dormant microbes and trace minerals are plentiful. When harvesting at these conditions, the microbes may help bring up trace minerals with them.

The treatment system of step 20 is now further described with reference to the system 110 of FIGS. 2-4. In general, seawater containing dormant microbes flows through the system 110 to separate out certain minerals, while retaining desirable trace minerals, and to provide a concentrate high in microbe and trace mineral content, where the microbes are preferably in a dormant state. The system 110 preferably operates as a gravity flow system, which may avoid or reduce the need for pumps or other energy-consuming motors. The system 110 may include an inlet 120, one or more filtration, mineralization and oxygenation chambers or assemblies 130, 140, one or more collection assemblies or chambers 150, and one or more seawater cleaning assemblies or chambers 160.

The embodiment of system 110 shown in FIGS. 2-4 includes two chambers 130, 140, where filtration, mineralization and oxygenation may occur, one collection chamber 150 where the supplement having a concentration of dormant microbes may be collected, and one seawater cleaning chamber 160. However, other numbers of such chambers may be used. For example, additional chambers may be used to scale up the production of the supplement. The sizes of the respective chambers may also vary and may be increased to scale up production. The number and size of the chambers of the system 110 may be varied to accommodate different applications, large or small, or otherwise.

It is preferred that the successive chambers 130, 140, 150, 160, and the conduits connecting them, be configured so that the seawater travels downward throughout system 110. In this manner, the system may rely on gravity to treat the seawater, as opposed to energy-consuming pumps or motors. This, in turn, reduces the cost of the treatment process, simplifies the design of system 110 and is eco-friendly. Indeed, the supplement of the current invention is derived from naturally occurring seawater rich in microbes and trace minerals, and relies on naturally occurring gravity to treat the seawater.

Seawater that has been harvested as described above may be introduced to system 110 at inlet 120. At this point, the seawater generally contains significant sodium chloride as well as other minerals normally existing in seawater. Also at this point, the microbes contained in the seawater are preferably alive but inactive or dormant as described above.

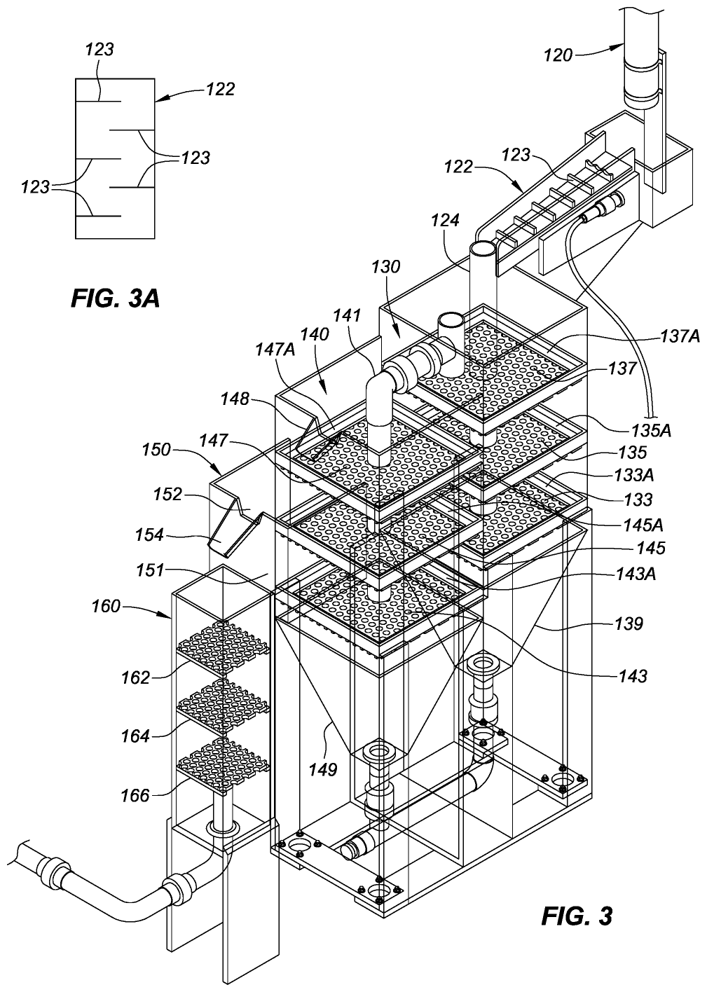

The seawater may then travel from inlet 120 through ramps, pipes or conduits to assemblies 130, 140 due to gravity. Preferably, the seawater travels from inlet 120 down ramp assembly 122 to filtration or clarifying chamber 130. As shown in FIG. 3A, ramp assembly 122 preferably includes barriers 123 that create a tortuous path for the seawater as it travels down the ramp 122. This preferably creates turbulence in the seawater and renders the sodium and chloride more easily separable and/or filterable by system 110 as described below.

The ramp 122 may direct the seawater to clarifying assembly 130 via feed tube, pipe or conduit 131 that extends downward to the bottom chamber 139 of clarifying assembly 130. As more seawater flows down ramp 122 and feed tube 131, the clarifying chamber 130 fills up due to the weight of the down flowing water through tube 131.

Filtration assembly or chamber 130 may include a series of tiered filters so that as the seawater fills the chamber 130 and the surface of the seawater rises, it undergoes several filtration stages. For example, the clarifying chamber 130 may include a first or lower filter 132 that may rest on a first or lower screen 133, that may in turn be supported by ledge 133A; a second or middle filter 134 that may rest on a second or middle screen 135, that may in turn be supported by ledge 135A; and a third or upper filter 136 that may rest on a third or upper screen 137, that may in turn be supported by ledge 137A. FIG. 2 shows the filters 132, 134, 136 resting on screens 133, 135, 137 and ledges 133A, 135A, 137A; while FIG. 3 more clearly shows screens 133, 135, 137 and ledges 133A, 135A, 137A with the filters removed.

As the seawater rises in clarifying chamber 130, the water first passes through screen 133, which may resemble a window screen or other perforated surface, and allows the seawater to pass through. The seawater may then encounter filter 132 which may generally comprise a porous shell containing a desired mix of filtering components. For example, the filter 132 may resemble a teabag having a porous outer shell containing a desired chemical composition to remove sodium and chloride. As such, the seawater may penetrate and pass through the outer shell on the filter bottom, interact with the chemical composition contained in the filter 132, and then continue to pass through the outer shell on the filter top.

The lower or first filter 132 may contain element(s) or component(s) that filter out sodium and chloride from the seawater, as well as a filler, such as sand. In a preferred embodiment, the filter 132 may contain about 90% of the filtering element(s) or component(s) and about 10% of a filler, such as sand. However, other percentages of these components may be used, and other filtering components may also be used. The filter components preferably serve to separate sodium and chloride from the seawater, such that as the seawater continues to rise above filter 132 in clarifying chamber 130, an amount of sodium and chloride will be separated out and ultimately fall downward and be collected in bottom chamber 139. The filter 132 may also separate out other undesirable minerals and/or heavy metals which may also be collected in bottom chamber 139. As such, the seawater that continues to rise above filter 132 has been treated, purified or filtered accordingly.

As this treated, purified or filtered seawater continues to rise above the filter 132, it encounters screen 135 and second or middle filter 134. The structure of the screen 135 may be similar to that of screen 133. The structure of filter 134 may be similar to that of the filter 132, i.e., a porous outer shell containing desired filtering components. In a preferred embodiment, the filtering components may be element(s) or component(s) that filter out sodium and chloride from the seawater, as well as a filler such as sand. The middle filter 134 may contain about 70% of the filtering element(s) or component(s) and about 30% filler, such as sand. In general, a lower percentage of the filtering element(s) or component(s) may be used in second filter 134, given the treatment or filtering that has already occurred through lower filter 132.

The filter components preferably further serve to separate sodium and chloride from the seawater, such that as the seawater continues to rise above filter 134 in clarifying chamber 130, additional sodium, chloride and fluorides will be separated out. The filter 134 may also separate out other undesirable minerals and/or heavy metals. As such, the seawater that continues to rise above filter 134 has been purified or filtered through two stages of filtering and is thus further treated, purified or filtered.

As this treated, purified or filtered seawater continues to rise above the filter 134, it encounters screen 137 and third or top filter 136. The structure of the screen 137 may be similar to that of screen 133 and/or 135. The structure of the filter 136 may be similar to that of filter 132 and/or 134, i.e., a porous outer shell containing desired filtering components. In a preferred embodiment, the filtering components may be element(s) or component(s) that filter out sodium and chloride from the seawater, as well as a filler such as sand. The third or top filter 136 may contain about 50% of the filtering element(s) or component(s) and about 50% filler, such as sand. In general, a lower percentage of the filtering element(s) or component(s) may be used given the treatment or filtering that has already occurred through lower filters 132, 134.

The filter components preferably further serve to separate sodium and chloride from the seawater, such that as the seawater continues to rise above filter 136 in clarifying chamber 130, additional sodium and chloride will be separated out. Filter 136 preferably also separates out magnesium. The filter 136 may also separate out other undesirable minerals and/or heavy metals. As such, the seawater that continues to rise above filter 136 has been purified or filtered through three stages of filtering.

As noted above, each filter 132, 134, 136 preferably separates out sodium and chloride from the seawater as well as any other bacteria or other undesirable materials. In this manner, as the seawater ascends from one chamber to another in clarifying assembly 130, more and more sodium and chloride, and other undesirable materials, are separated or filtered out.

At the same time, however, each filter 132, 134, 136 may introduce desirable minerals to the seawater being filtered. These minerals may vary but it is preferred that the minerals that are introduced are those which naturally exist in seawater, and which may be carried by the microbes that are later activated to enrich the soil or integrated with the plant or tree. As such, the seawater attains higher levels of the desired minerals that may promote growth in plants or trees.

After the treatment, filtration and/or mineralization stages that occur in clarifying assembly 130, the resulting treated seawater may continue to rise so that it flows into pipe or conduit 141, which directs the treated seawater from the top or upper chamber of clarifying assembly 130 to the bottom or lower chamber of oxygenation and/or clarifying assembly 140.

System 110 is preferably a gravity fed system, to avoid or reduce the need for pumps or other components that require energy to pump the seawater through the system 110. To this end, it is preferred that a sufficient pressure head, volumetric flow and/or other conditions exist so that the seawater flows through system 110, e.g., from clarifying assembly 130 to oxygenation and/or clarifying assembly 140. It is also preferred that the rate of flow of seawater through system 110 is regulated so that sufficient time is provided for the seawater to interact with the filters 132, 134, 136 in clarifying chamber 130 to allow a desired amount of purification or filtration, as well as mineralization, to occur.

The filters 132, 134, 136 may need to be changed over time, e.g., after enough seawater has passed through them that their contents no longer effectively interact with the sodium, chloride and other undesirable substances. In general, the effective lifespan of the filters depends on the sodium chloride percentage content in the seawater. For example, the filters may last longer when used with clearer seawater with lower sodium chloride levels.

Assembly 140 may include several chambers with screens and filters similar to those used in clarifying assembly 130. That is, filters 142, 144, 146 may comprise a porous outer shell containing oxygenation and/or filtering components, and the filters 142, 144, 146 may rest on screens 143, 145, 147, which may be supported by ledges 143A, 145A, 147A, respectively, as shown in FIG. 3. Assembly 140 may generally be positioned lower than assembly 130 to facilitate the gravity-fed aspect of system 110.

The level of the filtered seawater that flows into oxygenation and/or clarifying assembly 140 may rise up so that it first passes through screen 143 and filter 142. The lower or first filter 142 may contain a mixture of filtering material and a filler, such as sand. In a preferred embodiment, the filter 142 may contain about 90% of filtering materials and about 10% of a filler, such as sand. However, other percentages of these components may be used, and other oxygenation and/or filtering components may also be used.

It is preferred that the filtering material in filter 142 imparts oxygen to the seawater passing through. In this manner, oxygen is provided to the microbes in the seawater so that the microbes remain in a live, though inactive or dormant state, and do not die off. For example, the oxygen provided to the microbes through filter 142 may bring the microbes back from a near-death state to a healthier, though still dormant, state.

The filter 142 may further separate or filter out sodium, calcium, fluorides, magnesium and/or other heavy metals or undesirable elements. These materials may then collect in bottom chamber 149.

As the seawater continues to rise above filter 142 in chamber 140 it has preferably been oxygenated. It may also be further purified or filtered, and mineralized. As this seawater continues to rise above filter 142, it encounters screen 145 and second or middle filter 144. The second or middle filter 144 may contain about 70% of filtering material and about 30% filler, such as sand. In general, a lower percentage of filtering material may be used, given the oxygenation that has already occurred through lower filter 142.

As the further oxygenated seawater continues to rise above the filter 144, it encounters screen 147 and third or top filter 146. The third or top filter 146 may contain about 50% of filtering material and about 50% filler, such as sand. In general, a lower percentage of filtering material may be used given the filtering that has already occurred through lower filters 142, 144.

As noted above, each filter 142, 144, 146 preferably oxygenates the seawater as it rises up in assembly 140. In this manner, as the seawater ascends from one chamber to another in assembly 140, more and more oxygen is imparted to the seawater and the microbes therein to keep them in a live, but inactive or dormant, state.

One or more of filters 142, 144, 146 may also contain a component that causes a chain reaction or other interaction with the trace minerals in the seawater. This may cause the trace minerals to bind with the still-dormant microbes.

As discussed later in more detail regarding the application step 60 (of FIG. 1), the binding of trace minerals to microbes helps enrich the soil and promotes growth. That is, when the microbes later become active during the application step 60, the microbes can then carry the trace minerals, with which they are bound, to interact with and enrich the soil, or to engage the plant or tree. This is significant because without a microbe carrier, the trace minerals would likely not interact with the soil, or with the plants or trees. As such, the nutritional value of those trace minerals would be lost.

As the seawater level in assembly 140 continues to rise, it reaches a height so that it flows through a slot 148 that may be formed in the sidewall of the upper chamber of assembly 140. The filtered and oxygenated seawater may then flow into collection chamber 150.

The collection step 30 of FIG. 1 is now further described. As the filtered and oxygenated seawater flows through slot 148, it may enter the collection chamber 150 at or near its top, and thereafter fill collection chamber 150. When the collection chamber 150 is filled as the treatment process of system 110 continues, the level of the seawater rises so that it reaches a slot 152 that may be formed in a sidewall of collection chamber 150. The seawater then travels down ramp or other conduit 154 to a cleaning assembly 160.

As the filtered and oxygenated seawater passes through collection chamber 150, the microbes and trace materials in the seawater preferably descend or otherwise collect at the bottom of collection chamber 150. As more seawater cycles through collection chamber 150, more and more material that is high in microbe and trace mineral density is collected at the bottom of chamber 150. This sludge-like material may be retrieved through a valve or opening 151 in the floor of collection chamber 150.

The material retrieved represents the supplement of the current invention, and generally represents a microbe, trace mineral compound. It is preferred that the microbes remain in a dormant or inactive state during the collection step. In a preferred embodiment, the chemical formulation of the supplement or concentrate may be as follows (where the Method references indicated are based on the Official Methods of Analysis of AOAC International, 17th Edition, 1998; except that “Calculation” means calculation from lab data):

| | | Quantitation | |
|---|---|---|---|
| | Result | Limit | Method |
| Arsenic, mg/Kg | <0.500 | 0.500 | 6010D |
| Boron, mg/Kg | <2.50 | 2.50 | 6010D |
| Calcium, mg/Kg | 91.6 | 10.0 | 6010D |
| Cadmium, mg/Kg | <0.100 | 0.100 | 6010D |
| Copper, mg/Kg | <0.250 | 0.250 | 6010D |
| Iron, mg/Kg | 20.3 | 5.00 | 6010D |
| Magnesium, mg/Kg | 11.4 | 5.00 | 6010D |
| Manganese, mg/Kg | 1.39 | 0.500 | 6010D |
| Molybdenum, mg/Kg | <0.250 | 0.250 | 6010D |
| Sodium, mg/Kg | 679 | 25.0 | 6010D |
| Nickel, mg/Kg | <0.250 | 0.250 | 6010D |
| Lead, mg/Kg | <0.300 | 0.300 | 6010D |
| Selenium, mg/Kg | <0.500 | 0.500 | 6010D |
| Zinc, mg/Kg | <0.500 | 0.500 | 6010D |
| Mercury, mg/Kg | <0.0153 | 0.0153 | 7471A |
| Available Phosphorus | <0.10 | 0.10 | AOAC 993.31 |
| as P2O5, % | | | |
| Chloride, % | 1.14 | 0.50 | AOAC 928.02 |
| Cobalt, mg/Kg | <0.500 | 0.500 | 6010D |
| Potassium (as K2O), % | 5.21 | 0.210 | AOAC 958.02 |
| Total Nitrogen, % | 0.193 | 0.100 | AOAC 993.13 |
| Ammoniacal Nitrogen, % | 0.07 | 0.03 | AOAC 920.03 |
| Water Insoluble | 0.03 | 0.01 | AOAC 945.01 |
| Nitrogen, % | | | |
| Nitrate Nitrogen, % | 0.11 | 0.10 | Calculation |
| Total Sulfur, % | 0.12 | 0.01 | AOAC 980.02 |

The foregoing example of chemical formulation provides benefits over other existing fertilizer or concentrates based on seawater. For example, some existing products require that they be used within a certain amount of time after being exposed to air, e.g., 24 hours, because their chemical formulation is acidic. Such products use acidic substances to neutralize the chemistry of the treated seawater to eliminate a sufficient amount of salt so that the product is not too salty to use as a fertilizer or supplement. However, if such products are not used within a certain amount of time, the acidic substances detract from or completely eliminate any nutrient value provided by its chemical formulation.

However, the chemical formulation of the supplement of the current invention has no such restrictions. This is because its chemical formulation, such as that shown above, already has sufficiently lowered levels of sodium and chloride so that acidic neutralizing substances are unnecessary. As such, no temporal restriction on its use exists and the supplement has a longer shelf life, thereby allowing greater flexibility as to when and the manner in which it may be used.

The supplement may exist in a liquid form. However, in other embodiments of the current invention the supplement may be further processed so that it exists in a powder form. This processing may involve exposing the sludge-like material collected from the collection chamber 150 to the atmosphere to allow the seawater component still contained in the supplement to evaporate. This may result in a powder-like substance in which the microbes remain in a live, but inactive or dormant, state.

As noted above, the system 110 described above may be scaled up in size and/or number of chambers to produce larger quantities of supplement. Even with larger versions of system 110, however, the gravity fed nature of its operation still keeps its design relatively simple. This allows the system 110 to be portable and used even where there are no readily available power supplies, because pumps and motors are not required. In one embodiment, the system 110 may be housed in a shipping container, so that it may be shipped anywhere in the world to produce the microbial-based supplement. This may be especially beneficial to underdeveloped areas where crop yield may be insufficient to feed the local population. The portability of the system 110 allows it to readily operate in arid areas.

The storage step 40 of FIG. 1 is now further described. During the storage step, the storage environment containing the supplement is preferably maintained so that the microbes remain alive, but still in an inactive or dormant state. For example, it is preferred that the supplement be stored to avoid sunlight or other UV light. The supplement may also be stored at conditions that promote the microbes to multiply.

It should be noted that in prior art fertilizers or supplements involving seawater, any microbes that naturally existed in the seawater as originally harvested, would typically die or be killed off during any processing or storage steps. As such, the fact that microbes that are still alive in the supplement is a distinct difference from prior products.

Referring back to FIGS. 2-3, the seawater that flows through slot 152 from the collection chamber 150 is now further described. This seawater may flow down ramp or other conduit 154 into a cleaning assembly 160. The seawater may generally flow downward through assembly 160. Cleaning assembly 160 may comprise several tiers of filters 162, 164, 166 which may each clean the seawater as it passes through. The filters 162, 164, 166 may rest on screens which may in turn be supported by ledges as described in connection with chambers 130, 140.

In a preferred embodiment, filter 162 may comprise gravel, filter 164 may comprise coal and filter 166 may comprise sand. However, other filtering materials may be used. The seawater that has been cleaned as described above may be collected and extracted at the bottom of assembly 160.

The mixing step 50 is now further described. As noted above, the mineral supplement is preferably mixed with water or other soluble materials during this step. In a preferred embodiment, the resulting mixture may contain 0.5% supplement. However, other mixtures may be used such as 1% supplement. Besides water, other materials such as Osmocote may be mixed.

The relatively low percentage of supplement in the supplement/water mixture represents an advance over prior supplements. For example, the Rhizolizer® product typically accounts for 10% of the mixture. As such, a smaller amount of supplement is needed compared to Rhizolizer®, thereby saving on cost.

During the mixing step 50, it is preferred that the microbes remain alive, but still in an inactive or dormant state. As noted above, this is a significant difference to existing products in which the microbes would have all died if they were ever present in the product at all. This is also a significant difference to the Rhizolizer® product where the microbes are apparently active during the entire preparation process.

The application step 60 is now further described. During this step, the mixture of supplement and water may be sprayed or otherwise applied to soil, or to plants, trees or other agriculture. During this step, the microbes preferably become active due to the increased oxygen that is present upon application. The presence of natural sunlight may also aid in activating the microbes. However, the mixture may also be applied to indoor agriculture with the microbes becoming active.

The active microbes are thus available to help promote growth in addition to any minerals contained in the supplement mixture. In a preferred embodiment, the supplement mixture may be sprayed onto plants, trees or other living agriculture. It is preferred that the spraying process allows the supplement mixture, and the now-active microbes contained therein to become integrated into the leaves, stems, branches, trunks or other parts of the plants or trees, so that the plant or tree may serve as a host to the microbes.

In this situation, the microbes may directly provide nutrients to the plant or tree structure to promote growth throughout the remaining life of the microbes. To this end, the now-active microbes may reside on the plant or tree surface, or become embedded in the plant or tree surface, e.g., in the leaves thereof, and provide nutrients thereto. And after the microbes die off within or on the plant or tree structure, the microbes decompose thereby providing additional nutrients.

In an alternative application process 60, the supplement mixture may be spread into the soil surrounding the plants or trees, i.e., similar to a fertilizer. In this alternative, the microbes preferably integrate with the roots and soil to again provide nutrients for the remainder of their lives as well as after as they decompose.

Several studies have occurred using the supplement, and they have shown significant increases in plant and tree growth.

Besides promoting growth of plants and trees, spraying the supplement mixture also avoid issues associated with fertilizer runoff which occurs when “nitrogen-blasted” field experience rain.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A mineral supplement for promoting growth of agriculture comprising:
treated seawater comprising seawater that has been filtered to reduce the amount of sodium and chloride naturally found in the seawater, and that includes microbes that are alive but in a dormant state.

2. The mineral supplement of claim 1, wherein the treated seawater comprises seawater that has been harvested at a depth wherein at least some of the microbes contained therein are alive but in a dormant state.

3. The mineral supplement of claim 1, wherein the treated seawater comprises filtered seawater that has been mineralized with added minerals and oxygenated.

4. The mineral supplement of claim 1, wherein the concentration of microbes that are alive but in a dormant state is higher in the treated seawater than in naturally existing seawater.

5. The mineral supplement of claim 1 in a powder form.

6. The mineral supplement of claim 1 in a liquid form.

7. A system for providing a mineral supplement comprising treated seawater containing microbes that are alive but in a dormant state, the system comprising:
at least one treatment or clarifying assembly, through which the seawater flows and that treats the seawater to reduce its levels of sodium and chloride;
at least one collection assembly to collect the supplement with a higher concentration of microbes that are alive but in a dormant state than naturally exist in seawater; and
at least one cleaning assembly

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. The mineral supplement of claim 1, further comprising water and/or liquid fertilizer.

20. The mineral supplement of claim 19, wherein the treated seawater constitutes 0.5% to 1.0% of the mineral supplement.

21. A mineral supplement for promoting growth of agriculture comprising:
filtered seawater comprising seawater that has been filtered to reduce the amount of sodium and chloride that naturally exists in the seawater; and
a concentration of microbes that are alive but in a dormant that is higher than the concentration of such microbes that naturally exists in the seawater.

22. The mineral supplement of claim 21, wherein the filtered seawater comprises seawater that has been harvested at a predetermined depth wherein at least some of the microbes contained therein are alive but in a dormant state.

23. The mineral supplement of claim 21, further comprising added minerals and oxygen.

24. The mineral supplement of claim 21 in a powder form.

25. The mineral supplement of claim 21 in a liquid form.

26. The mineral supplement of claim 21, further comprising water and/or liquid fertilizer.

27. The mineral supplement of claim 21, wherein the treated seawater constitutes 0.5% to 1.0% by weight of the mineral supplement.
